(19) United States
(12) Patent Application Publication
(10) Pub. No.: US 2016/0358069 A1
(43) Pub. Date: Dec. 8, 2016

(54) NEURAL NETWORK SUPPRESSION

(71) Applicant: Samsung Electronics Co., Ltd., Gyeonggi-Do (KR)

(72) Inventors: John W. Brothers, Calistoga, CA (US); Joohoon Lee, East Palo Alto, CA (US)

(21) Appl. No.: 15/099,109

(22) Filed: Apr. 14, 2016

Related U.S. Application Data
(60) Provisional application No. 62/170,282, filed on Jun. 3, 2015.
(60) Provisional application No. 62/191,266, filed on Jul. 10, 2015.

(51) Int. Cl. G06N 3/08; G06F 7/76; G06N 3/04

(52) U.S. Cl. CPC G06N 3/08; G06N 3/04; G06F 7/764

(57) ABSTRACT

Implementing a neural network includes determining whether to process a combination of a first region of an input feature map and a first region of a convolution kernel and, responsive to determining to process the combination, performing a convolution operation on the first region of the input feature map using the first region of the convolution kernel to generate at least a portion of an output feature map.

### CROSS-REFERENCE TO RELATED APPLICATIONS

This application claims the benefit of U.S. Provisional Application No. 62/170,282 filed on Jun. 3, 2015, and U.S. Provisional Application No. 62/191,266 filed Jul. 10, 2015, both of which are fully incorporated herein by reference.

### TECHNICAL FIELD

This disclosure relates to neural networks and, more particularly, to reducing computations in neural networks using suppression.

### BACKGROUND

Neural networks refer to a computational architecture modeled after biological brains. Within a neural network, nodes referred to as neurons may be interconnected and operate collectively to process input data. Examples of different types of neural networks include, but are not limited to, Convolutional Neural Networks, Recurrent Neural Networks, Deep Belief Networks, Restricted Boltzman Machines, etc. In a feedforward neural network, the neurons of the neural network have links to other neurons. The links only extend in one direction, i.e., the forward direction, through the neural network.

A neural network may be used to extract “features” from complex input data. The neural network may include a plurality of layers. Each layer may receive input data and generate output data by processing the input data to the layer. The output data may be a feature map of the input data that the neural network generates by convolving an input image or a feature map with convolution kernels. Initial layers of a neural network may be operative to extract low level features such as edges and/or gradients from an input such as an image. Subsequent layers of the neural network may extract progressively more complex features such as eyes, a nose, or the like.

### SUMMARY

One embodiment may include a method of implementing a neural network. The method includes determining whether to process a combination of a first region of an input feature map and a first region of a convolution kernel and, responsive to determining to process the combination, performing a convolution operation on the first region of the input feature map using the first region of the convolution kernel to generate at least a portion of an output feature map.

Another embodiment may include an apparatus for implementing a neural network. The apparatus includes a fetch circuit configured to retrieve regions of input feature maps from a memory under control of a control circuit and a mask generation and weight application control circuit configured to determine whether to process a combination of a first region of an input feature map and a first region of a convolution kernel. The apparatus further includes a convolution circuit configured to perform a convolution operation on the combination responsive to the determination by the mask generation and weight application control circuit to process the combination.

Another embodiment may include an apparatus for implementing a neural network. The apparatus includes a weight processing circuit configured to determine whether weights to be applied to regions of input feature maps are zero and a data staging circuit configured to determine whether the regions of the input feature maps are zero. The apparatus also includes a multiply-accumulate circuit configured to apply only non-zero weights to the regions of the input feature maps that are non-zero.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 is a diagram illustrating an exemplary neural network engine (NN engine).

FIG. 2 is a diagram illustrating another exemplary implementation of an NN engine.

FIG. 3 is a flow chart illustrating an exemplary method of operation for an NN engine.

FIG. 4 is a flow chart illustrating another exemplary method of operation for an NN engine.

FIG. 5 is a diagram illustrating another exemplary NN engine.

FIG. 6 is a flow chart illustrating another exemplary method of operation for an NN engine.

FIG. 7 is a diagram illustrating exemplary decompression of weights and traversal of non-zero weights by an NN engine.

FIG. 8 is a diagram illustrating retrieval of regions of input feature maps from memory for processing by an NN engine.

FIGS. 9-14 are diagrams illustrating an example of applying weights using zero weight skipping by an NN engine.

FIGS. 15-1 and 15-2 are diagrams illustrating an example of processing an input feature map by an NN engine.

FIG. 15-3 is a diagram illustrating an example of concurrent processing of input feature maps by multiple NN engines.

FIG. 16 is a diagram illustrating an exemplary engine for processing one or more classification layers of a neural network or for vector product processing.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to neural networks and, more particularly, to reducing computations in neural networks. A number of neural networks implement forward execution that involves a large number of multiply-and-accumulate (MAC) operations to extract “features” like edges, gradients, blobs, or higher level features like a nose, eye, or the like. Examples of these forward execution neural networks include, but are not limited to, Convolutional Neural Networks (CNNs), Recurrent Neural Networks (RNNs), Deep Belief Networks (DBNs), and Restricted Boltzman Machine (RBM). In a number of cases, convolutions, which are implemented using MAC operations, comprise approximately 90% of the computational cost of neural network execution, performance, and/or power. Example embodiments of a neural network (NN) engine described herein reduce the number of MAC operations while maintaining accuracy of the overall neural network, thereby improving efficiency.

For example, spiking neural networks (SNNs) are another variant of neural networks that work in a different way from CNNs (and other NN's like CNN's) in some aspects. In SNNs, inputs to a “neuron” computational unit are spikes and are weighted according to the “synaptic strength” of the connections. The sum of the weighted spikes added to a “post-synaptic potential” of the neuron are compared to a threshold value and a spike is generated by the neuron when the sum of the added spikes and post-synaptic potential exceeds the threshold. One effect of this thresholding is that a number of portions of the neural network have no spikes since no sufficiently significant features of a given type are detected in most locations.

For purposes of illustration, consider a NN engine that detects, among other features, 45 degree edges. A particular image might have very few 45 degree edge pixels as a percentage of the overall image. Since there are no spikes in most places of the image in connection with 45 degree edge detection, there is little to no computation to be done in most of the network. This is the case since neurons with no input spikes do not generate output spikes; and, no computation is required for these neurons. Further, the neurons to which these inactive neurons are connected are also less likely to become active. The thresholding feature of SNN's has the effect of suppressing activity in most of the network which reduces computation and related power.

The embodiments disclosed herein may be used with CNNs and with related non-spiking neural network types without having to convert the neural network to an SNN implementation. While SNNs have power advantages, SNNs also exhibit reduced accuracy given a similar network topology, e.g., in the case of a CNN being converted to an SCNN. In accordance with the inventive arrangements described herein, power and performance advantages similar to those of an SNN may be achieved for a CNN without requiring support of SNN acceleration and without redefinition of the neural network to convert to a spiking implementation. These benefits may be achieved using low-cost and non-invasive changes to the CNN implementation. In one aspect, network suppression may be applied in CNNs and in other non-spiking network variants to save power and improve performance while maintaining a similar level of accuracy as in a network where no suppression is implemented.

Methods and systems for executing a neural network are disclosed. The example embodiments described herein facilitate improved power and performance of neural network execution for CNNs and for related neural networks. In one aspect, activity within non-critical portions of a neural network may be selectively and dynamically suppressed or skipped. For example, the NN engine, while convolving a weight matrix and an input feature map, can determine whether each computation of the convolution satisfies a condition. An example condition is that the computation includes a zero input value and/or a zero weight value. In other words, satisfying the condition indicates that the computation does not affect the final computation. Thus, the NN engine does not process the computation in response to detecting a condition and does process the computation in response to detecting the condition.

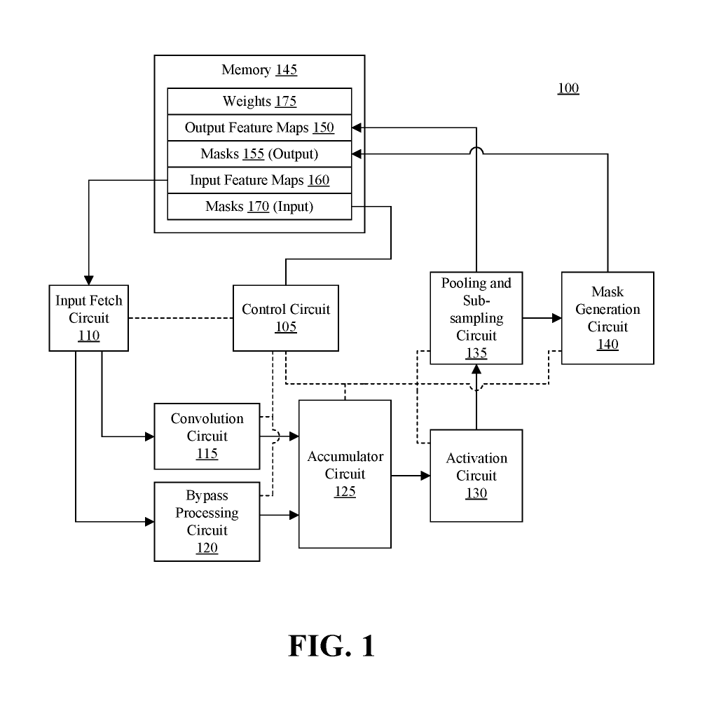

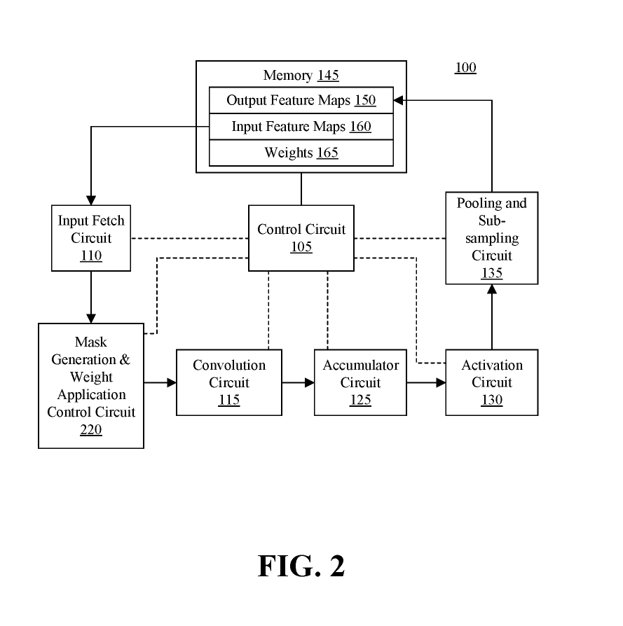

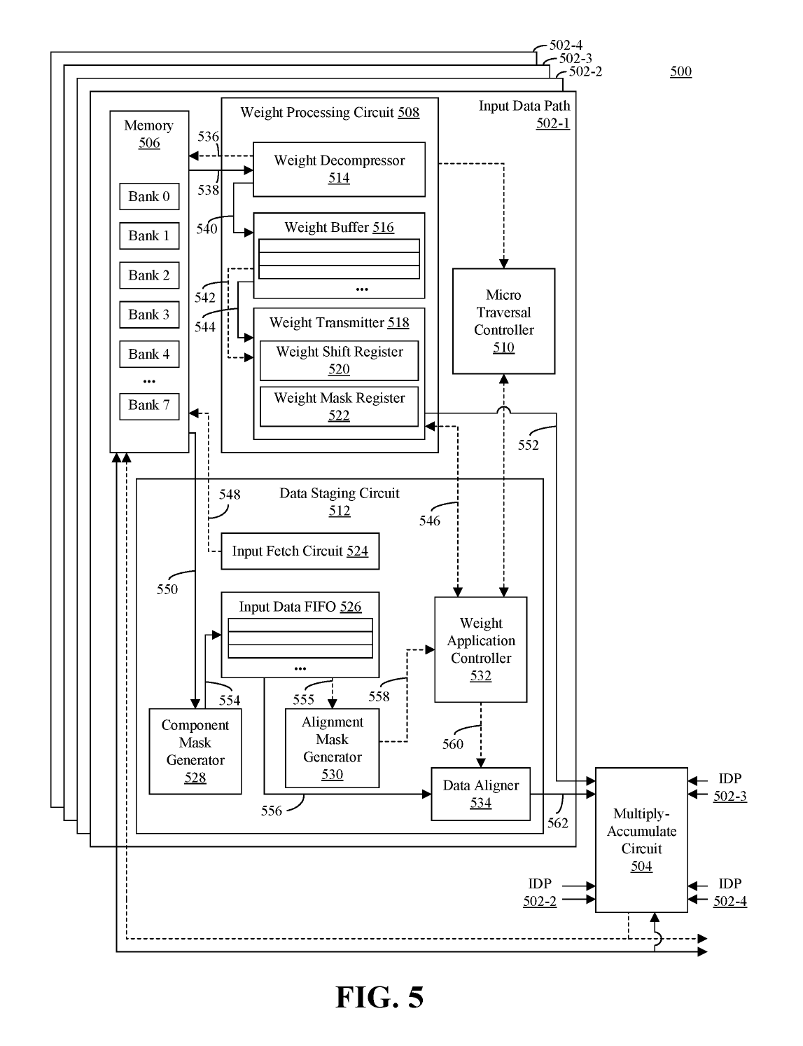

The NN engine can detect the condition that determines whether to skip or suppress regions of the NN in a number of ways. In an example embodiment, the regions of the neural network that are suppressed may be tracked at the output side of the layer so that processing of suppressed regions in the next layer may be skipped. An example embodiment is described in greater detail in connection with FIG. 1. It will be appreciated that the condition to determine whether a computation is to be skipped can be detected on the input side when the input value and the weight value is read from memory. Example embodiments are described in greater detail in connection with FIGS. 2 and 5.

In doing so, performance of the neural network in terms of processing speed can be increased, while power consumption of the neural network is reduced. The ability to skip over processing of suppressed regions increases performance and may reduce power beyond the power savings already achieve by conversions of MACs to multiplies by zero and adds of zero to the accumulator. The example embodiments described herein can eliminate a number of portions of the network activity with a low impact on accuracy.

In still another aspect, since neural networks utilize complex function approximations, the operations performed by a neural network may be modified and approximated to a degree without significant impact to the overall accuracy of the neural network. Also, where approximations do impact accuracy, the effect of the approximations on accuracy can be mitigated through additional network training.

FIG. 1 is a diagram illustrating an exemplary neural network engine (NN engine) 100. NN engine 100 is configured to execute a neural network such as a CNN or other neural network similar to a CNN. NN engine 100 may be configured to implement a suppression mechanism and/or a tracking and logic bypass mechanism. Suppression may be implemented within NN engine 100 in a variety of different circuit blocks as described herein in greater detail below.

NN engine 100 is generally described in the context of processing input feature maps of a neural network to generate output feature maps to be consumed by a next layer of the neural network. As pictured, NN engine 100 includes a control circuit 105. Control circuit 105 is configured to control and coordinate operation of input fetch circuit 110, convolution circuit 115, bypass processing circuit 120, accumulator circuit 125, activation circuit 130, pooling and sub-sampling (PSS) circuit 135, and mask generation circuit 140.

For purposes of illustration, dotted lines represent control signals provided from control circuit 105 to the various circuit blocks of NN engine 100. Solid lines represent data signals among the circuit blocks. The arrows on the data lines indicate the general flow of data through NN engine 100 and, as such, are not intended to indicate unidirectional flow of data. The data signals may represent bidirectional data flows that may be implemented to effectuate communication and data exchange among the circuit blocks. Further, the control signals may be bidirectional.

In one embodiment, control circuit 105 is configured to read masks 170 and, in response, instruct input fetch circuit 110 as to which ones of input feature maps 160 are to be retrieved. In one aspect, masks are used to track which regions of the neural network are suppressed and, as such, should be bypassed and/or processed differently than regions that are not suppressed. As defined within this disclosure, the term “suppressed region,” in reference to a feature map, is a region where each value of the region is the same or substantially the same whether by natural operation of the NN engine or by application of suppression (e.g., by quantizing or clamping) by the NN engine.

In the example of FIG. 1, NN engine 100 may maintain a mask (e.g., one mask) per feature map to track suppressed regions of feature maps. Each mask field, for example, represents an R×S rectangular region of the corresponding feature map, where R and S are integer values. Each mask field may be implemented as 1 bit or as 2 or more bits. In one embodiment, NN engine 100 tracks regions of all 0 values and regions of all 1 values. In that case, each mask field may be 2 bits. Each field indicates whether the values of the corresponding region of the feature map are all 0s or all 1s. In another embodiment, NN engine 100 only tracks suppressed regions of all 0 values. In that case, each mask field may be 1 bit. Yet other embodiments, either additional or alternatively, track regions having the same value or substantially the same value. Moreover, FIGS. 2 and 5 show example embodiments wherein activity is suppressed at the computation level (e.g., computations involving at least one zero-valued input value or weight value).

FIG. 1 illustrates an example where mask generation circuit 140 is operable to generate masks post-operation of PSS circuit 135. Further, the example of FIG. 1 stores masks for use in processing subsequent or different layers of the neural network. Other embodiments described within this disclosure operate differently in that mask generation may occur responsive to reading data from local memory and be performed dynamically such that masks need not be stored for processing subsequent or different layers of the neural network. FIGS. 2 and 5 illustrate example embodiments that utilize dynamic mask generation. Furthermore, FIGS. 2 and 5 describe embodiments that can omit the bypass processing circuitry 120. Instead, these embodiments have one processing path that processes computations involving both non-zero input and weight values. Computations involving at least one zero input value or weight value can be skipped.

Referring again to FIG. 1, in one exemplary implementation, the dimension R equals the dimension S. In addition, the mask may be larger for feature maps that are read using a larger receptive field (or convolution footprint). For example, if a feature map is the input to an 11×11 convolution, the dimensions R and S may be 16. For a 5×5 convolution, the dimensions R and S may be 8 or 9. Smaller values for dimensions R and S provide fine grain ability to inhibit unneeded convolutions in smaller suppressed regions at the cost of more mask overhead. In general, the mask overhead is small.

Input fetch circuit 110 reads input feature maps 160 from memory 145 under control of control circuit 105. More particularly, input fetch circuit 110 retrieves selected regions of input feature maps 160 under control of control circuit 105. In one embodiment, control circuit 105, in reading masks 170, may determine which regions of input feature maps 160 require processing and which regions of input feature maps 160 do not require processing. A mask 170 that indicates a region of all zeros, for example, indicates that the region does not require processing. In that case, control circuit 105 may instruct input fetch circuit 110 to skip the region. Of the regions of input feature maps 160 that do require processing, control circuit 105 may determine whether the regions are to be processed through convolution circuit 115 or through bypass processing circuit 120. Weights 175 may be stored in memory 145 or in another memory coupled to NN engine 100.

Input fetch circuit 110 reads regions of input feature maps 160 as instructed by control circuit 105 and provides the regions to convolution circuit 115 or to bypass processing circuit 120. Convolution circuit 115 applies convolution kernels to the regions of input feature maps fetched by input fetch circuit 110. For example, convolution circuit 115 may convolve a first input feature map 160 with a first filter, convolve a second input feature map 160 with a second filter, etc., for a given region. Operation of bypass processing circuit 120 is described in greater detail below.

Accumulator circuit 125 may receive outputs from convolution circuit 115 and bypass processing circuit 120. Accumulator circuit 125 sums the partial results on a per region basis. Activation circuit 130 is configured to receive the summed results from accumulator circuit 125 and apply the activation function to the summed result. Activation circuit 130 may generate an output to PSS circuit 135.

In one embodiment, activation circuit 130 is configured to apply suppression by quantizing received inputs. Activation circuit 130 may perform the quantizing selectively according to a comparison of the received input to one or more suppression thresholds. For example, whenever the input to the activation function is below a lower suppression threshold, activation circuit 130 causes the output of the activation function to be zero. In another example, whenever the input to the activation function is above an upper suppression threshold, activation circuit 130 causes the output of the activation function to be a maximum value (“MAX_VALUE”) such as all ones. In one exemplary embodiment, activation circuit 130 may implement a piecewise linear approximator implementation of the activation function so that thresholding, or quantization, may be applied with little to no cost.

PSS circuit 135 generates output feature maps 150 and stores the resulting output feature maps 150 in memory 145. For example, given a 16×16 output feature map, PSS circuit 135 may take the maximum value at each 2×2 portion and sub-sample down to an 8×8 output feature map that may be written to memory 145 as an output feature map 150.

In another embodiment, PSS circuit 135 applies suppression. For example, during pooling, PSS circuit 135 may scan over the outputs of activation circuit 130 and generate an average or maximum value in a sliding window of neighboring outputs from activation circuit 130. PSS circuit 135 may perform threshold comparisons at low cost. By performing suppression during pooling, the quantization logic takes into account values of adjacent nodes and conditions the suppression on a group of values. Considering a group of values can facilitate reducing or minimizing the introduction of artificial edges where NN engine 100 transitions from a region of no suppression values to a region of suppressed values, and vice versa.

Suppression may be performed using thresholding by either activation circuit 130 or PSS circuit 135. In any case, as pictured, PSS circuit 135 is coupled to mask generation circuit 140. PSS circuit 135 may provide the output feature maps 150 to mask generation circuit 140. Mask generation circuit 140 creates a mask 155 for each of output feature maps 150 that is stored within memory 145 as shown. In general, mask generation circuit 140 may perform zero detection as mask generation circuit 140 generates masks 150 that are then used as input masks (e.g., masks 170) in processing the next layer of the neural network. NN engine 100 may continue processing and iterate as described to process further layers of the neural network. As discussed, in other embodiments, e.g., as pictured in FIGS. 2 and 5, masks may be generated dynamically as data is read from memory and need not be stored for processing feature maps in subsequent layers of the neural network.

In one embodiment, in addition or alternative to detecting low feature strength and clamping (or quantizing) to zero, NN engine 100 may be configured to bypass convolution operations by detecting high feature strength and clamping (or quantizing) to MAX_VALUE or by quantizing the feature map values to create areas of flatness. As defined herein, the phrase “area of flatness” means a group of neighboring values in a feature map where the values are substantially the same or are the same. An area of flatness further may refer to an area where the values are not all maximum values and are not all zero values. Values are substantially the same when the values are within a predefined range of one another. NN engine 100 may be configured to detect portions of a feature map that are flat. In response to detecting receptive fields for a set of adjacent nodes in a flat region, NN engine 100 may bypass the convolution operations and instead add the convolution weights, and multiply the summed weights by the constant value of the flat region called a scaling factor. The scaling factor may be an average of the values of a flat region in the case where the values are substantially the same, but not equivalent. In the case where the values of a flat region are the same, the scaling factor may be the value. The convolution weights may be read from weights 175.

For example, bypass processing circuit 120 may be configured to perform bypass processing operations such as summing weights and multiplying the summed weights by the scaling factor of the flat region. The quantization described herein is similar to local contrast renormalization, but results in a limited number of discrete values. The limited number of discrete values, e.g., 8 or 16, preserve range, but reduce precision. Quantization can have the effect of creating bands or contours of equal values where activations fall into a narrow range. For convolutions whose inputs land within these contours, NN engine 100 can bypass convolution circuit 115 and instead sum the weights and scale the result by the value of the flat region using bypass processing circuit 120. Input fetch circuit 110 may provide the region to the appropriate circuit block under control of control circuit 105 responsive to reading masks 170.

In another embodiment, when generating a feature map in a next layer (e.g., layer N+1) that uses an input feature map in layer N with feature suppression enabled, control circuit 105 may determine whether the current output region, for example, a 4×4 block, maps back to a region in layer N that is completely suppressed according to the corresponding mask. The mask may be all 0s or all 1s. Responsive to detecting that the region in layer N is all 0s, for example, control logic 105 instructs input fetch circuit 110 to skip the region and select another region for processing. In the case where the input region is all 1s, bypass processing circuit 120 may output a number equaling a sum of the convolution weights multiplied by the scaling factor (which is 1 in this case) for all nodes in the output region. This scaled sum of weights is at least approximately equal to the output if convolution circuit 115 performed convolution.

To support cases where the input feature map has been quantized to relatively few levels resulting in flat bands, control circuit 105 may be configured to detect flat regions in addition or in the alternative to detecting a coarse mask of all 0s or all 1s. For example, control circuit 105 may read actual regions from input feature maps 160 and detect that all values of particular regions are the same or are substantially the same. In that case, control circuit 105 may instruct input fetch circuit 110 to again skip reading or fetching the region of the input feature map 160 and instruct bypass processing circuit 120 to generate and output a sum of the weights scaled by the scaling factor as determined from the values of the flat region. Control circuit 105, for example, may provide bypass processing circuit 120 with the scaling factor and the instruction to generate the scaled sum.

As discussed, NN engine 100 is operative to generate masks. In one arrangement, NN engine 100 may loop through all of the output regions to generate a feature map X in a layer N. NN engine 100 may determine a sum of convolutions in an input region of each feature map in layer N−1. Further, NN engine 100 may generate a region of an output feature map. For example, NN engine 100 may apply the activation function and/or perform pooling and sub-sampling.

The following operations relating to mask generation may be performed by NN engine 100 as part of the activation function stage or as part of the pooling and sub-sampling stage. NN engine 100 may determine whether all outputs are less than a lower suppression threshold (TL). If so, NN engine 100 may set the mask field corresponding to this region of the output feature map to all “zero.” If not, NN engine 100 may determine whether all outputs of the region are greater than an upper suppression threshold (TH). If NN engine 100 determines that all outputs of the region are greater than the upper threshold, NN engine 100 may set the mask field corresponding to this region of the output feature map to “all 1.”

In the case where all outputs are not less than the lower suppression threshold or not greater than the upper suppression threshold, NN engine 100 may set the mask field corresponding to the region of the output feature map to “not all 1” or “not all 0.” In any case, NN engine 100 may update the intermediate data memory with the node values. For example, mask generation circuit 140 may be configured, as noted, to perform the checking and update the mask field as described. PSS circuit 135 may be configured to store the resulting data in memory.

NN engine 100 may determine whether the last region for the current feature map in layer N is generated. If so, NN engine 100 completes processing of the current feature map. NN engine 100 may continue to process regions of another feature map in layer N. If the last region for the current feature map is not generated, NN engine 100 may continue to the next region for the current feature map in layer N. Control circuit 105 may be configured to track the particular region of the current feature map that is being processed.

As discussed, NN engine 100 is operative to apply suppression using masks. In one arrangement, NN engine 100 may generate a feature map X of a layer N of a neural network. NN engine 100 may determine whether the region being processed is the last region for the output feature map X. If so, NN engine 100 may discontinue processing or move to the next output feature map or the next layer, as the case may be.

If the region being processed is not the last region, NN engine 100 may start generation of a next rectangular output region for feature map X. Accordingly, NN engine 100 may begin processing a region of the next input feature map. NN engine 100 may read the mask field corresponding to the current region of the current input feature map. For example, control circuit 105 may read the mask field. The mask field indicates whether the region of the input feature map being processed is to undergo general convolution processing as performed by convolution circuit 115, be skipped, or undergo bypass processing as may be performed by bypass processing circuit 120.

In one aspect, control circuit 105 may determine whether the mask field indicates that the region is all 0s or all 1s. If NN engine 100 determines that the region is all 0s, for example, the region may be skipped. In that case, the region is not processed through the convolution path and is effectively bypassed. In another aspect, the region may be provided to bypass processing circuit 120 which may ignore the received input, output zeros, or the like.

If NN engine 100 determines that the region is all 1 s, the region is to be processed through bypass processing circuit 120 to generate the convolution results. In one example, control circuit 105 may instruct input fetch circuit 110 to retrieve the region and provide the region to bypass processing circuit 120. Control circuit 105 may provide bypass processing circuit 120 with the scaling factor to be used. In another example, control circuit 105 may instruct input fetch circuit 110 not to retrieve the region and instruct bypass control circuit 120 to generate the sum of weights and scale by the scaling factor.

If NN engine 100 determines that the region is not all 0s and is not all 1s, NN engine 100 may follow the convolution path to generate the input layer's contribution to the current output feature map. For example, control circuit 105 may instruct input fetch circuit 110 to retrieve the region and provide the region to convolution circuit 115.

NN engine 100 may add the result for the current input feature map to the accumulators. Accumulator circuit 125 sums the results. NN engine 100 may determine whether all input feature maps have been processed. If so, NN engine 100 may run a sum of convolved values through the activation function. For example, activation circuit 130 may apply the activation function to the received sum. As discussed, in one embodiment, activation circuit 130 may also apply suppression. In one example, activation circuit 130 may compare the received input to a lower suppression threshold. Responsive to activation circuit 130 determining that the input is less than the lower suppression threshold, activation circuit 130 may output zero values for the region. In another example, activation circuit 130 may compare the received input to an upper suppression threshold. Responsive to activation circuit 130 determining that the output is greater than the upper suppression threshold, activation circuit 130 may output the MAX_VALUES for the region. NN engine 100 may continue processing until the input feature maps have been processed.

The NN engine of FIG. 1 is provided for purposes of illustration only. In other arrangements, the bypass processing circuit may be configured to calculate the scaling factor to be used instead of receiving the scaling factor from the control circuit. For example, responsive to receiving a region, whether all zeros, all ones, or a flat region, the bypass processing circuit may detect the all zero condition, the all one condition, or calculate an average of the values of the region that may be used as the scaling factor.

FIG. 2 is a diagram illustrating another exemplary implementation of NN engine 100. NN engine 100 is configured to execute a neural network such as a CNN or other neural network similar to a CNN. NN engine 100 may be configured to implement a suppression mechanism and/or a tracking and logic bypass mechanism. Suppression may be implemented within NN engine 100 with regard to weights of the neural network and to input data. For example, in cases where either one or both the weights or the input data is zero, processing of a region of an input feature map may be skipped. Further, NN engine 100 is an exemplary implementation where masks indicating suppressed regions of the neural network are not stored within memory and passed between layers of the neural network as was the case with FIG. 1.

As discussed with reference to FIG. 1, control signals are represented using dashed lines. Data signals are represented using solid lines. The arrows on the data lines indicate the general flow of data through NN engine 100 and, as such, are not intended to indicate unidirectional flow of data. The data signals may represent bidirectional signals that may be implemented to effectuate communication and data exchange among the circuit blocks. The controls signals may also be bidirectional.

NN engine 100 includes a control circuit 105. Control circuit 105 is configured to control and coordinate operation of input fetch circuit 110, convolution circuit 115, mask generation & weight application control circuit (MGWAC circuit) 220, accumulator circuit 125, activation circuit 130, and PSS circuit 135. NN engine 100 may operate substantially similar to the example of FIG. 1 with respect to accumulator circuit 125, activation circuit 130, and PSS circuit 135. In the example of FIG. 2, masks need not be stored in memory 145. Memory 145 may store output feature maps 150, input feature maps 160, and weights 165. In another aspect, weights 165 may be stored in another memory coupled to NN engine 100.

Input fetch circuit 110 may retrieve, or read, input feature maps 160 and weights 165 from memory 145 under control of control circuit 105. In one embodiment, MGWAC circuit 220 may be configured to determine whether a region of an input feature map 160 retrieved from memory 145 is suppressed. While control circuit 105 may track and indicate which regions and input feature maps are to be retrieved by input fetch circuit 110 for purposes of control, MGWAC circuit 220 is configured to determine whether the region is suppressed. In one embodiment, at least with regard to FIG. 2, MGWAC circuit 220 determines whether the region includes all zero values. Further, MGWAC circuit 220 may be configured to determine whether the weights to be applied to a given region are all zero values.

In one embodiment, MGWAC circuit 220 is configured to determine which combinations of regions and weights are non-zero. For example, MGWAC circuit 220 may evaluate a region and the weight to be applied to the region. In the event that all values of the region are zero, the weight to be applied to the region is zero, or both, MGWAC circuit 220 does not provide the combination of the region and the weight to convolution circuit 115. In one aspect, MGWAC circuit 220 determines the next combination of region and weight that are both non-zero. In the event that the region is not all zeros and the weight is non-zero, MGWAC circuit 220 provides the combination of the non-zero region and the non-zero weight to convolution circuit 115 for processing. The result from convolution circuit 115 may be provided to accumulator circuit 125.

In one embodiment, MGWAC circuit 220 determines that the combination of a region and weight is to be processed responsive to determining that the region of the input feature map includes a value other than zero and that the corresponding region, e.g., a weight, of the convolution kernel includes a value other than zero. MGWAC circuit 220 may generate one or more masks indicating zero and non-zero portions of regions of input feature maps and/or regions of convolution kernels. The masks may be generated on the fly, e.g., responsive to reading a region of an input feature map and/or a region of a convolution kernel from memory 145.

For example, MGWAC circuit 220 may generate a first mask indicating zero and non-zero portions of a first region of an input feature map and generate a second mask indicating zero and non-zero portions of a first region of a convolution kernel. MGWAC circuit 220 may compare the first mask and the second mask. In this regard, MGWAC circuit 220 may determine that convolution processing of a region of the input feature map and a region of the convolution kernel are to be skipped responsive to determining that region of the input feature map, the region of the convolution kernel, or both includes all zero values.

In the example of FIG. 2, thresholding may be performed by activation circuit 130 or by PSS circuit 135 as discussed with reference to FIG. 1. Appreciably, PSS circuit 135 may write output feature maps 150 to memory 145 and need not provide output feature maps 160 to other circuits for further processing (e.g., mask generation). In one embodiment, only thresholding to clamp values to zero may be performed.

The example NN engine illustrated in FIG. 2 is provided for purposes of illustration only. Further aspects of NN engine operation and alternatives are described in greater detail with reference to the remaining figures.

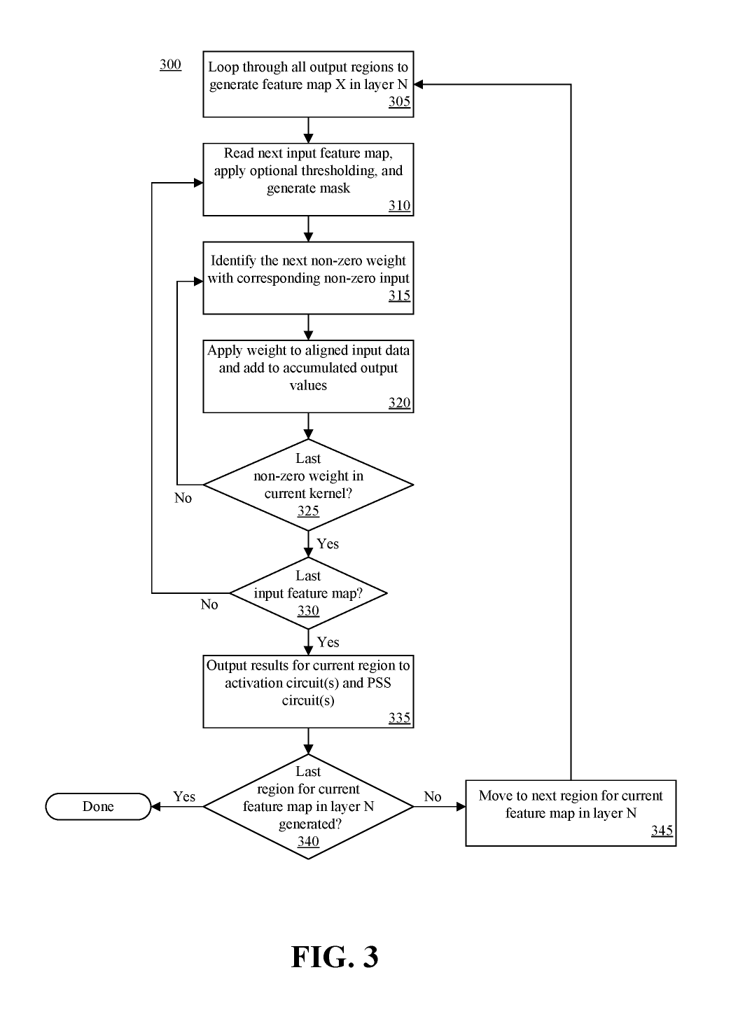

FIG. 3 is a flow chart illustrating an exemplary method 300 of operation for an NN engine such the NN engine of FIG. 2. In block 305, the NN engine may loop through all of the output regions to generate a feature map X in layer N of the neural network. In block 310, the NN engine may read a next input feature map, optionally apply thresholding, and generate a mask. The mask may indicate whether the various regions of the input feature map have all zero values.

In block 315, the NN engine may identify the next non-zero weight with a corresponding non-zero input. For example, the NN engine may identify the next non-zero weight that is to be applied to a region of an input feature map where the region does not have all zero values. In block 320, the NN engine may apply the weight to aligned input data, e.g., the non-zero region, and add the result to accumulated output values.

In block 325, the NN engine may determine whether the weight just processed in block 320 is the last non-zero weight in the current kernel. If so, method 300 may continue to block 330. If not, method 300 may loop back to block 315 to continue processing. Continuing with block 330, the NN engine may determine whether the input feature map processed in block 320 is the last input feature map in the current layer. If so, method 300 may proceed to block 335. If not, method 300 may loop back to block 310 to continue processing.

In block 335, the NN engine may output results for the current region to the activation circuit(s) and the PSS circuit(s). In block 340, the NN engine may determine whether the last region for the current feature map in layer N has been generated. If so, method 300 may end. If not, method 300 continues to block 345 where the NN engine moves to the next region for the current feature map in layer N. After block 345, method 300 may loop back to block 305 to continue processing.

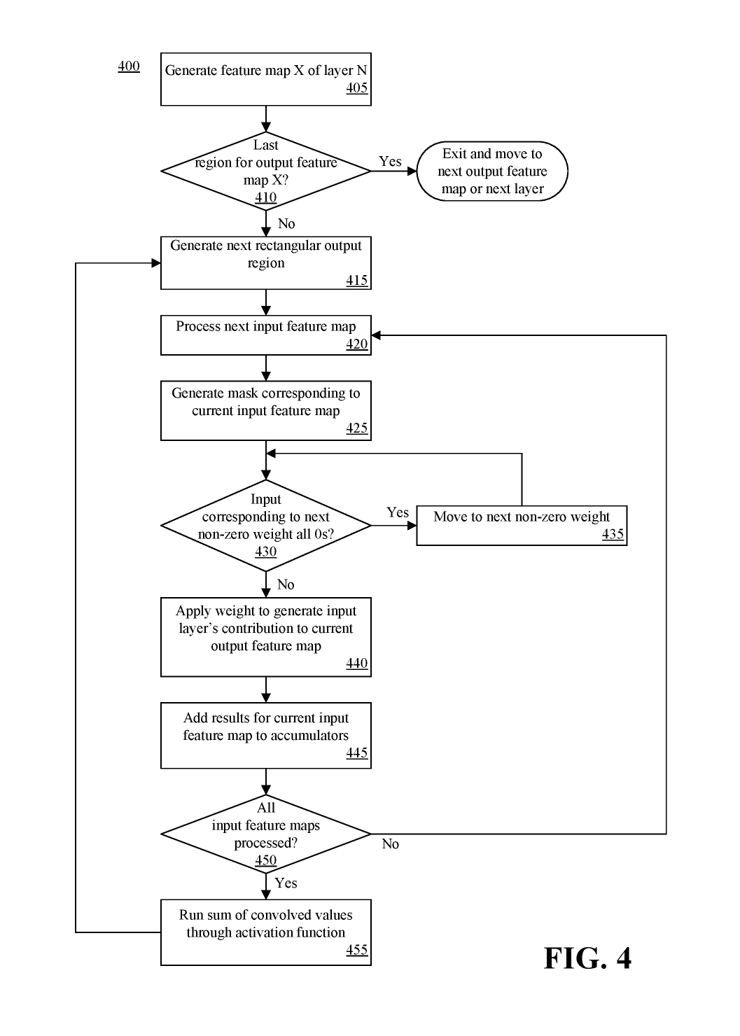

FIG. 4 is a flow chart illustrating an exemplary method 400 of operation for an NN engine such as the NN engine of FIG. 2. In block 405, the NN engine may generate a feature map X of layer N of a neural network. In block 410, the NN engine may determine whether a last region for the output feature map X has been processed. If so, method 400 may exit and move to the next output feature map or the next layer. If not, method 400 may proceed to block 415.

In block 415, the NN engine may generate a next rectangular output region. In block 420, the NN engine may process a next input feature map. For example, the NN engine may begin processing of the next input feature map in block 420. In block 425, the NN engine may generate a mask corresponding to the current input feature map. In the example of FIG. 4, the mask indicates which regions, if any, of the current input feature map have all zero values. In block 430, the NN engine may determine whether an input corresponding to a next non-zero weight has all zero values. The input within block 430 is a region of the current input feature map selected for processing. If the region for the next non-zero weight has all zero values, method 400 continues to block 435. In block 435, the NN engine moves to the next non-zero weight. Thus, processing of the input in the case where either the weight to be applied or the region has all zero values is skipped. After block 435, the method loops back to block 430 where a next input corresponding to a non-zero weight is evaluated.

Referring again to block 430, if the region for the next non-zero weight does not have all zero values, method 400 proceeds from block 430 to block 440. In block 440, the NN engine applies the weight to generate the input layer's contribution to the current output feature map. For example, the convolution circuit may apply the weight. In block 445, the NN engine adds the results for the current input feature map to the accumulator(s). For example, convolution circuit may provide the result to the accumulator circuit.

In block 450, the NN engine may determine whether all of the input feature maps have been processed. If so, method 400 may continue to block 455. If not, method 400 may loop back to block 420 to continue processing. In block 455, the NN engine may run a sum of the convolved values through the activation function. For example, the accumulator circuit may send the sum of convolved values to the activation circuit. It should be appreciated that the results from the activation function may be further processed through the PSS circuit as previously described.

FIG. 5 is a diagram of another exemplary NN engine 500. NN engine 500 is configured to execute a neural network such as a CNN or other neural network similar to a CNN. NN engine 500 may be configured to implement a suppression mechanism and/or a tracking and logic bypass mechanism. Suppression may be implemented within NN engine 500 with regard to weights of the neural network and to input data. For example, in cases where either one or both the weights or the input data is zero, processing of a region of an input feature map may be skipped.

NN engine 500 includes a plurality of input data paths 502 coupled to multiply-accumulate circuit 504. In the example of FIG. 5, NN engine 500 includes four input data paths 502-1, 502-2, 502-3, and 502-4. Each input data path 502 includes a memory 506, a weight processing circuit 508, a micro traversal controller 510, and a data staging circuit 512. As discussed with reference to FIG. 1, control signals are represented using dashed lines. Data signals are represented using solid lines. Arrows on the lines indicate the general flow of data through NN engine 500 and, as such, are not intended to indicate unidirectional flow of data. The data signals may represent bidirectional signals that may be implemented to effectuate communication and data exchange among the circuit blocks. Similarly, in FIG. 5, arrows on control signals indicate general direction of control and are not intended to indicate unidirectional communication. Control signals may be bidirectional.

For purposes of illustration, NN engine 500 is configured to operate on 4×4 regions of input feature maps. Accordingly, bit widths of the various signals described with reference to NN engine 500 use the 4×4 region size. It should be appreciated that other region sizes may be used. For example, regions of size 2×2 may be used to provide increased granularity in determining whether to skip operations. Using a smaller sized region (or a larger sized region as the case may be) will result in different bit widths for the various signals described. As such, the exemplary signal sizes are not intended as limitations of the embodiments described herein.

Micro traversal controller 510 is configured to provide base addresses and dimensions to weight processing circuit 508 and data staging circuit 512. The term “dimensions” refers to the number of feature maps per layer of the neural network, the tile size, weight matrix dimension, and the like. Micro traversal controller 510, for example, may be configured to generate the control signals to weight processing circuit 508 and data staging circuit 512 for traversal through the 4×4 regions and feature maps for a (e.g., one) tile of one or more convolution layers or to generate 16 outputs from all inputs in fully connect layers.

Memory 506 is configured to store a subset of the weights of the neural network in a compressed format and a subset of the input feature maps. Weights may be stored in a compressed format using any of a variety of known compression technologies. As pictured, memory 506 is configured to include eight banks. In one embodiment, memory 506 may be implemented as a static random access memory (SRAM) device. Further, memory 506 may be implemented as an on-chip memory with weight processing circuit 508 and data staging circuit 512. For example, a chip or integrated circuit may include each of the plurality of data paths 502, other modules for other types of processing and control (e.g., multiply-accumulate circuits, PSS circuits, etc.), communication with another external memory, command parsing, etc.

Weight processing circuit 508 includes a weight decompressor 514, a weight buffer 516, and a weight transmitter 518. Weight decompressor 514 may read weights from memory 506 via control signal 536 and data signal 538. Control signal 536, for example, may be a bank and line select signal. Data signal 538 may be a 128-bit data signal. As noted, weights may be stored in memory 506 in compressed format. In general, weight decompressor 514 may read compressed weights from memory 506 and store the decompressed weights in weights buffer 516 via data signal 540. Weight decompressor 514 may read weights needed for processing a particular 4×4 region of an input feature map at a time, e.g., 16 weights at a time, in compressed format. Weight decompressor 514, responsive to receiving the compressed weights, may decompress the weights, with each weight being 8 or 9 bits in size.

Weight decompressor 514 is further configured to generate a 16-bit weight mask indicating which of the weights to be applied to the 4×4 region are zero. Weight decompressor 514 may store the non-zero decompressed weights in weights buffer 516 through data signal 540 as part of a weight buffer entry. The decompressed weights require, at most, 128 bits of the weight buffer entry presuming all 16 weights are non-zero. Weight decompressor 514 is further configured to store the 16-bit weight mask indicating the x, y positions of the non-zero weights. For example, the 16-bit mask indicates those weights for the 4×4 region to be processed that have weights with a zero value (e.g., using a zero in the corresponding bit position of the mask, wherein a one indicates a non-zero weight). The 16-bit mask may be stored within the entry with the decompressed weights resulting in 144-bit entries. In this regard, data signal 540 may be a 144-bit signal.

The 16-bit mask and the weights from weights buffer 516 are provided to weight transmitter 518. In one embodiment, weight transmitter 518 may read the weights via data signal 544, which may be a 128-bit signal. The weights may be read by weight transmitter 518 via data signal 544 and stored in a weight shift register 520. The 16-bit weight mask may be read by weight transmitter 518 via control signal 542 and stored in weight mask register 522. Weight transmitter 518 is configured to shift out one non-zero weight each clock cycle (cycle) over data signal 552 to multiply-accumulator circuit 504, e.g., to a first port.

In one aspect, weights may be broadcast out of weight transmitter 518 to multiple locations. For example, while a non-zero weight is 8 bits in width, data signal 552 may be 128 bits in width allowing the weight to be sent to more than one location. Multiply-accumulate circuit 504, for instance, may have multiple inputs that each receive the same weight.

Data staging circuit 512 is configured to fetch 4×4 regions of input feature maps from memory 506 and generate a zeros mask. In one aspect, weight transmitter 518 knows the position of each weight for application to the 4×4 region, e.g., using the 16-bit weight mask, and sends the information to weight application controller 532 via control signal 546. Weight application controller 532, based upon the information received from weight transmitter 518, instructs input fetch circuit 524 to multiplex out the corresponding x, y region of input data, e.g., a region of an input feature map to be processed using the 4×4 weights retrieved by weight processing circuit 508. Input fetch circuit 524, for example, is configured to generate an address within memory 506 to retrieve the region, e.g., a 4×4 region of an input feature map, and provides the address to memory 506 via control signal 548. Control signal 548 may be a bank and select line. The retrieved region is provided to data staging circuit 512, and more particularly, to component mask generator 528, from memory 506 via signal 550.

Component mask generator 528 is configured to generate masks for retrieved regions of input feature maps indicating which contiguous 4×4 regions are zero. In one aspect, component mask generator 528 receives 16 8-bit values (a 4×4 region of input data) as 128 bits of data via data signal 550. For each 8-bit value, component mask generator 528 may perform a logical OR operation of the 8-bits to generate one bit of a 16-bit component mask, where each bit specifies whether the corresponding value of the 4×4 region is zero. Component mask generator 528 may write the 128 bits of data and the generated component mask to an entry in input data first-in-first-out (FIFO) 526 through data signal 554. Data signal 554 and each entry in input data FIFO 526 may be 144-bits in width.

Alignment mask generator 530 is configured to read the 16-bit component masks from input data FIFO 526 via control signal 555. Alignment mask generator 530 is configured to determine whether the entire 4×4 region, at each alignment, is zero based upon the component mask read from input data FIFO 526. For example, alignment mask generator 530 is configured to generate a further 16-bit mask called an alignment mask using the component masks. There are 16 possible alignments for a 4×4 region. Alignment mask generator 530 is coupled to weight application controller 532 through control signal 558. Control signal 558 may be a 16-bit signal. Through control signal 558, alignment mask generator 530 informs weight application controller 532 whether the input data is zero for all alignments for a given weight via control signal 558. It should be appreciated that weight application controller 532, per operation of weight processing circuit 508, receives only non-zero weights.

Data aligner 534 is configured to read the 4×4 regions from entries of input data FIFO 526. For example, for a given component mask read by alignment mask generator 530 from an entry in input data FIFO 526, data aligner 534 may read the values of the 4×4 region from the same entry via data signal 556. Data signal 556 may be a 128-bit signal.

Weight application controller 532 determines whether all input data is zero for a given weight as determined by alignment mask generator 530. Responsive to determining that a weight corresponds (e.g., is to be applied to) a 4×4 region of all zeros (hereafter a “zero region”) weight application controller 532 causes processing of the weight and region to be skipped. For example, weight application controller 532 may instruct data aligner 534, via control signal 560, not to output the zero region read from input data FIFO 526 to multiply-accumulate circuit 504 through data signal 562. Responsive to determining that a weight corresponds to a 4×4 region that is not all zeros, weight application controller 532 may instruct data aligner 534 to output the region to multiply-accumulate circuit 504 through signal 562.

In one embodiment, weight application controller 532 is further configured to provide instructions to weight transmitter 518 via control signal 546. For example, weight application controller 532 may instruct weight transmitter 518 whether to transmit a weight to multiply-accumulate circuit 504 through data signal 552. In those cases where the input data is zero, as determined by alignment mask generator 530, weight application controller 532 may instruct weight transmitter 518 not to transmit a non-zero weight to multiply-accumulate circuit 504. In fact, weight application controller 532 will directly identify the first non-zero weight with non-zero input data and process that combination, rather than iteratively searching for such a combination, thus eliminating cycles where no processing would be done.

Multiply-accumulate circuit 504, as pictured, may receive weights and data from additional input data paths 502-2, 502-3, and 502-4. In the example of FIG. 5, NN engine 500 includes four input data paths. In other exemplary implementations, more input data paths may be provided. For example, 8 or 16 input data paths may be provided. Regions may be 2×2 rather than 4×4 for example.

Though not illustrated in FIG. 5, NN engine 500 may also include activation circuitry and pooling and sub-sampling circuitry as described with reference to FIGS. 1 and/or 2 that operates on outputs from multiply-accumulate circuit 504. Further, suppression may be implemented in an activation stage or in a pooling and sub-sampling stage of NN engine 500 as described herein.

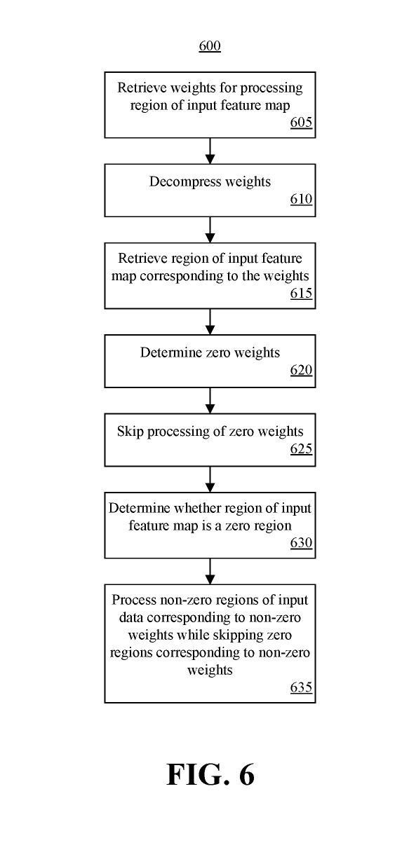

FIG. 6 is a flow chart illustrating an exemplary method 600 of operation for an NN engine. Method 600 illustrates a general method of operation that may be implemented by an NN engine such as NN engine 500 of FIG. 5 that is configured to skip processing responsive to detecting zero conditions in the input data and/or in the weights.

Method 600 may begin in block 605 where the NN engine may retrieve weights for processing a region of an input feature map from a memory. The weights may be stored in the memory in a compressed format. In block 610, the NN engine decompresses the weights. In block 615, the NN engine retrieves the region of the input feature map that is to be processed using the weights retrieved in block 605.

In block 620, the NN engine determines zero weights. The NN engine determines which of the weights retrieved in block 605 have zero values. In block 625, the NN engine skips processing for the zero weights. For example, the NN engine may suppress further transmission of weights that have zero values so that the weights with zero values are not applied to the region of the input feature map retrieved in block 615. Cycles otherwise devoted to applying a weight of zero value may be used to apply non-zero weights. Zero value weights can also be determined offline prior to network execution and this information be included in the weight data, for example, as part of the compression format.

In block 630, the NN engine may determine whether the region of the input feature map is all zero, i.e., is a zero region. As discussed, the NN engine may determine which values of the region are zero and determine whether the values are all zero for each possible alignment of the region. In block 635, the NN engine may process non-zero regions of the input data using the corresponding non-zero weights while skipping processing of zero regions that correspond to non-zero weights. For example, responsive to determining that a non-zero weight is to be applied to a zero region, the NN engine may skip processing of the zero region and the weight. The NN engine may not transmit the zero region or the non-zero weight to the multiply-accumulate circuit. Non-zero regions corresponding to non-zero weights are provided to the multiply-accumulate circuit for processing.

FIG. 6 illustrates general processing of regions. It should be appreciated that method 600 may be iterated to process further regions of an input feature map, further input feature maps, and additional layers of the neural network. For ease of illustration, stages such as the activation stage and the pooling and sub-sampling stage are not described.

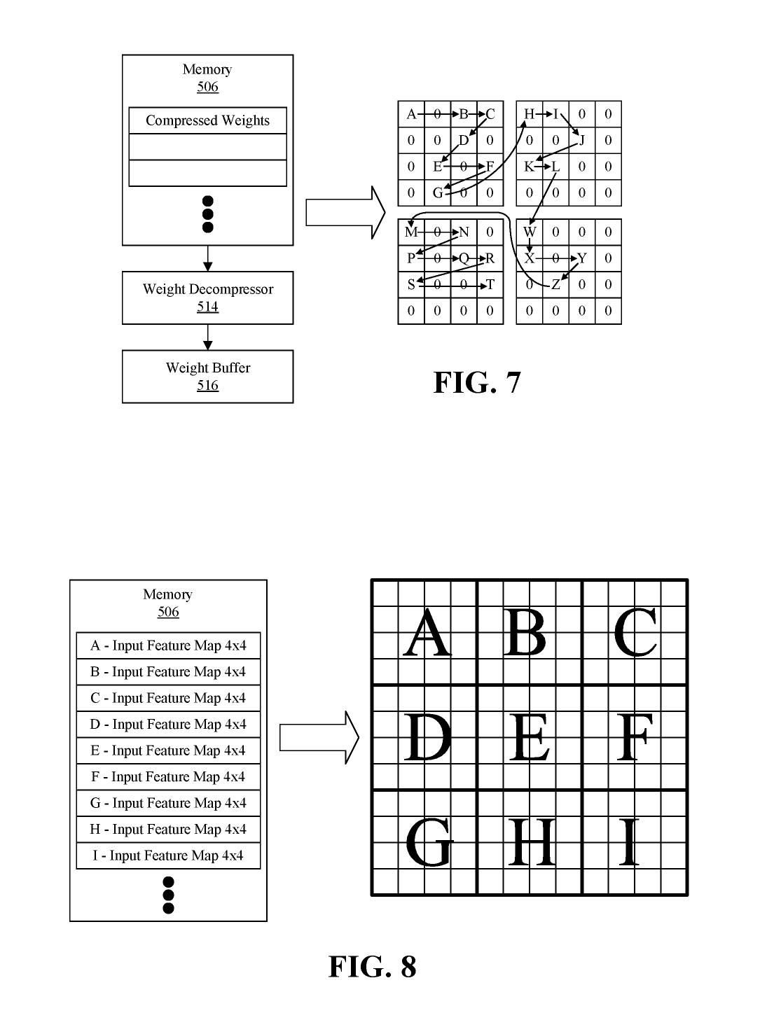

FIG. 7 is a diagram illustrating exemplary decompression of weights and traversal of non-zero weights by the NN engine of FIG. 5. As pictured, weight decompressor 514 reads compressed weights from memory 506 and stores the decompressed weights in weight buffer 516. Weight decompressor 514 further generates weight masks that may be stored within weight buffer 516 with the decompressed weights. The right-hand side of FIG. 7 illustrates exemplary output from weight decompressor 514. FIG. 7 illustrates an example using a 7×7 weight matrix represented using four different 4×4 weight matrices. The letters A, B, C, D, E, F, G, H, I, J, K, L, M, N, P, Q, R, S, T, W, X, Y, and Z represent non-zero weights.

As pictured, the weights of each respective quadrant of the decompressed weights were initially compressed together in memory 506. Weights are also applied in quadrant order with weights A-G being applied before weights H-L. Following weights H-L, weights W-Z are applied. Following weights W-Z, weights M-T are applied. In one embodiment, weight transmitter 518 may be configured to output non-zero weights in the order illustrated in FIG. 5, i.e., output weight A, then weight B, then weight C, etc. For example, weight transmitter 518 may include logic to traverse the non-zero weights in the order shown while skipping zero weights. Zero weights, for example, are not output from weight transmitter 518.

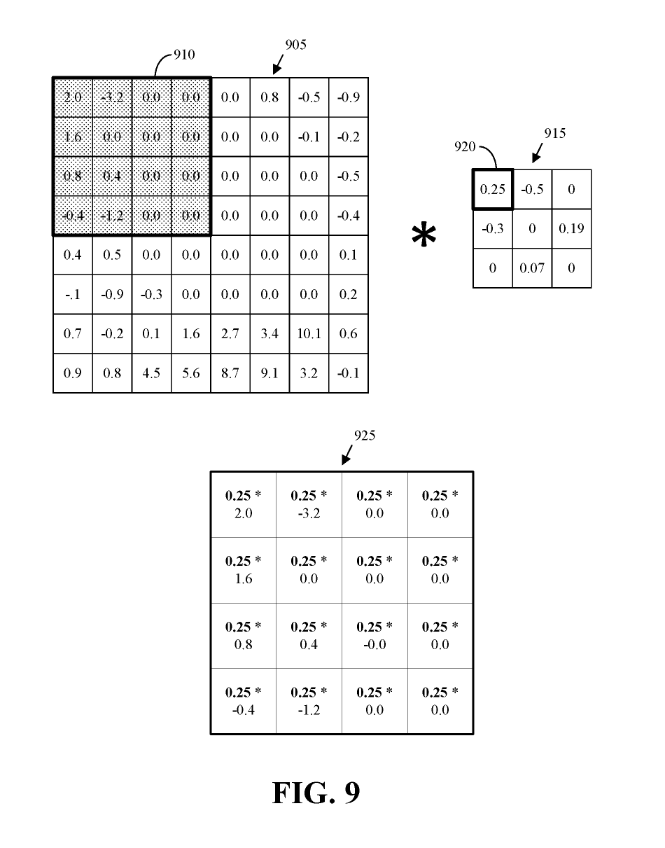

FIG. 8 is a diagram illustrating retrieval of regions of input feature maps from memory for processing by the NN engine of FIG. 5. As pictured, memory 506 also stores input feature maps in 4×4 regions. The right-hand side of FIG. 8 illustrates the spatial layout of the regions of the input feature maps stored in memory 506. Each of regions A, B, C, D, E, F, G, H, and I is a 4×4 region of an input feature map. As the 4×4 regions are fetched from memory by input fetch circuit 524, component mask generator 528 and alignment mask generator 530 generate component masks and alignment masks on the fly, e.g., dynamically during operation of NN engine 500. The reference letters used in FIG. 8 are for purposes of illustration only and are not correlated to, or the same as, the reference letters used to represent non-zero weights in FIG. 7.

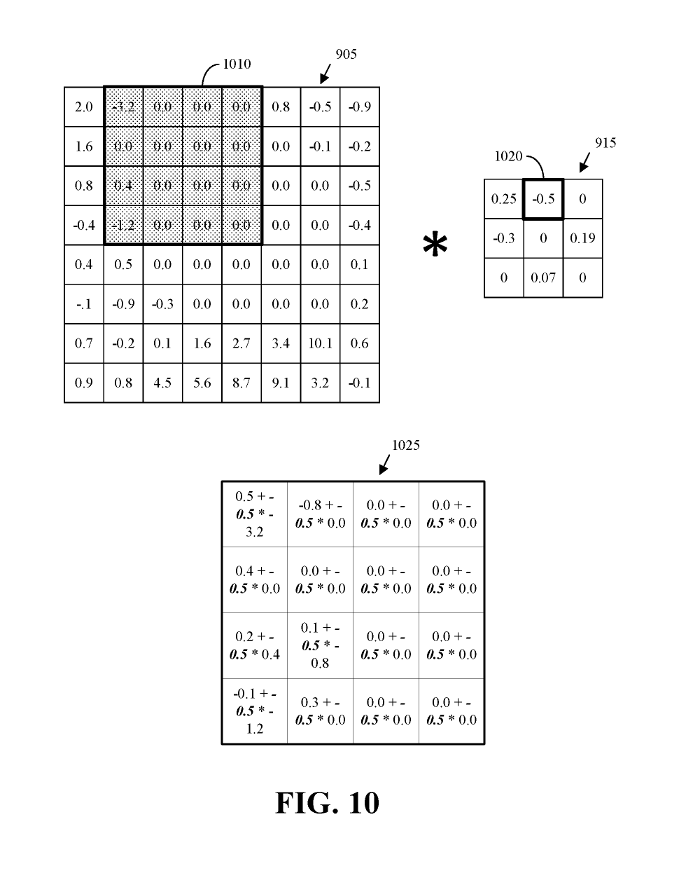

FIGS. 9-14 are diagrams illustrating an example of applying weights using zero weight skipping. FIGS. 9-14, taken collectively, illustrate exemplary operations that may be performed over a plurality of consecutive cycles to illustrate zero skipping for weights.

FIG. 9 illustrates exemplary processing that may be performed in a first cycle. Within FIG. 9, a 4×4 region 910 of an input feature map 905 is processed using non-zero weight 920 of weight matrix 915. Application of weight 920 to region 910 results in an output region 925.

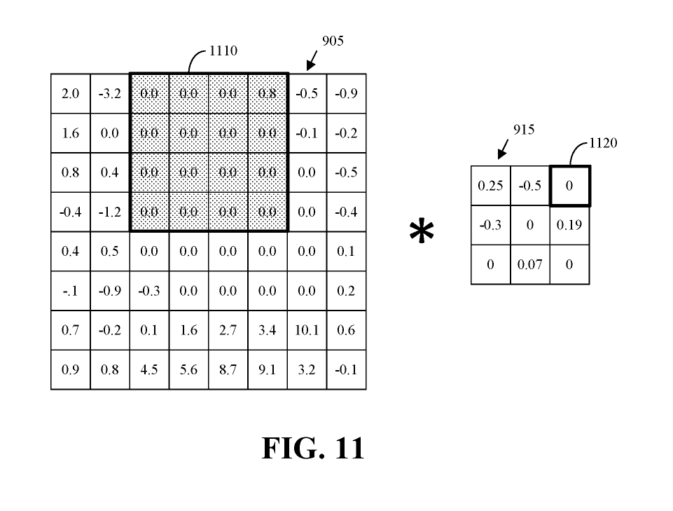

FIG. 10 illustrates exemplary processing that may be performed in a second cycle.

Within FIG. 10, a 4×4 region 1010 of input feature map 905 is processed using non-zero weight 1020 of weight matrix 915. Application of weight 1020 to region 1010 results in an output region 1025.

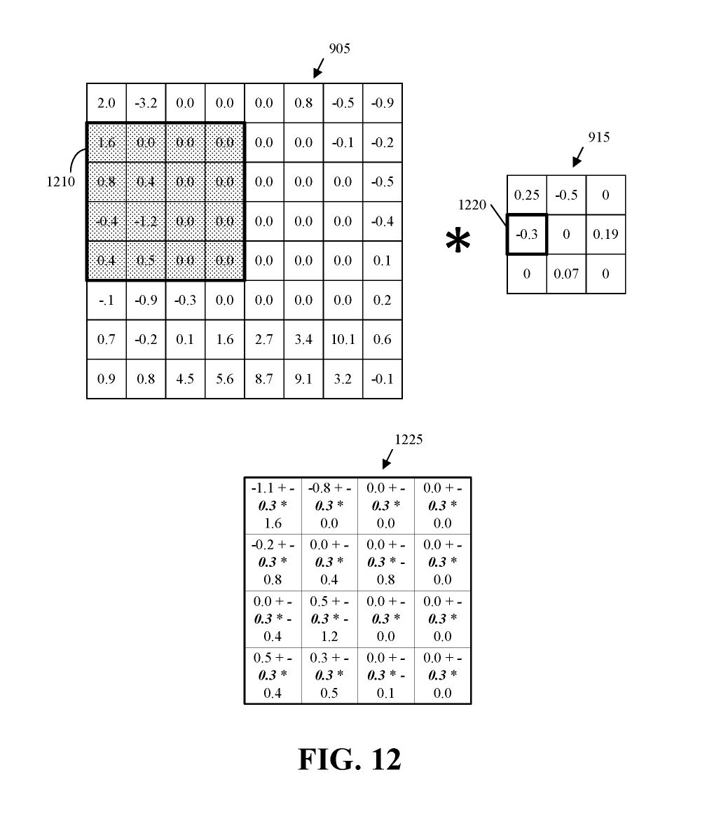

Referring to FIG. 11, the next weight to be processed is weight 1120 within weight matrix 915 having a value of zero. Because weight 1120 has a value of zero, however, weight 1120 is skipped. Accordingly, processing of 4×4 region 1110 is skipped in FIG. 11. No cycles are consumed and no output is generated for weight 1120 and region 1110.

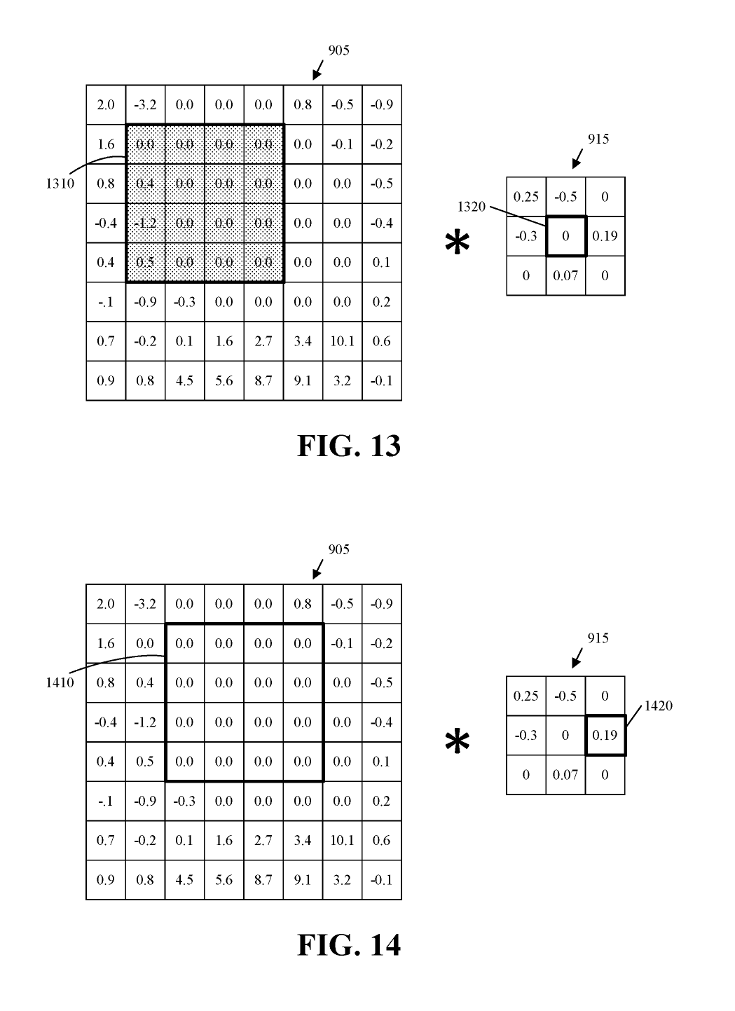

FIG. 12 illustrates exemplary processing that may be performed in a third cycle. Within FIG. 12, a 4×4 region 1210 of input feature map 905 is processed using non-zero weight 1220 of weight matrix 915. Application of weight 1220 to region 1210 results in an output region 1225.

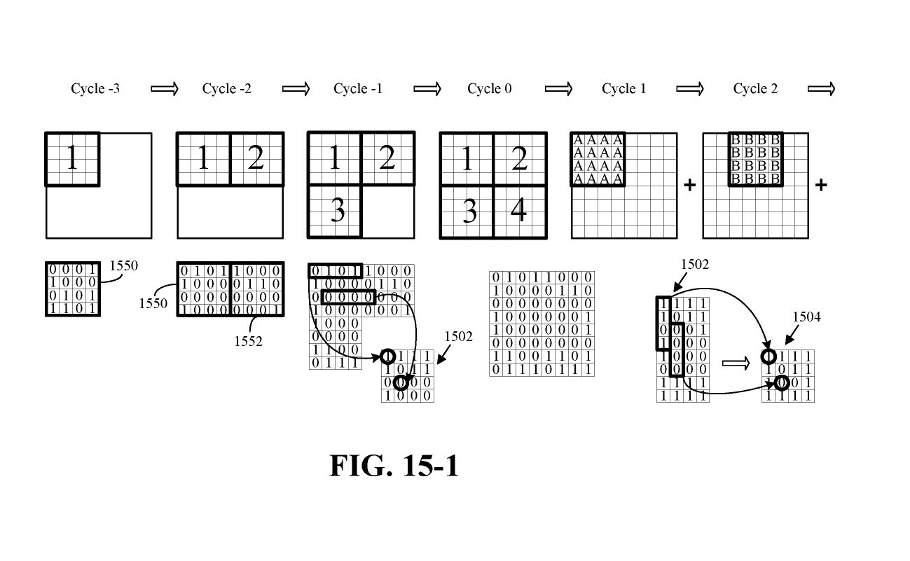

Referring to FIG. 13, the next weight to be processed is weight 1320 within weight matrix 915 having a value of zero. Because weight 1320 has a value of zero, however, weight 1320 is skipped. Accordingly, processing of 4×4 region 1310 is skipped in FIG. 13. No cycles are consumed and no output is generated for weight 1320 and region 1310.

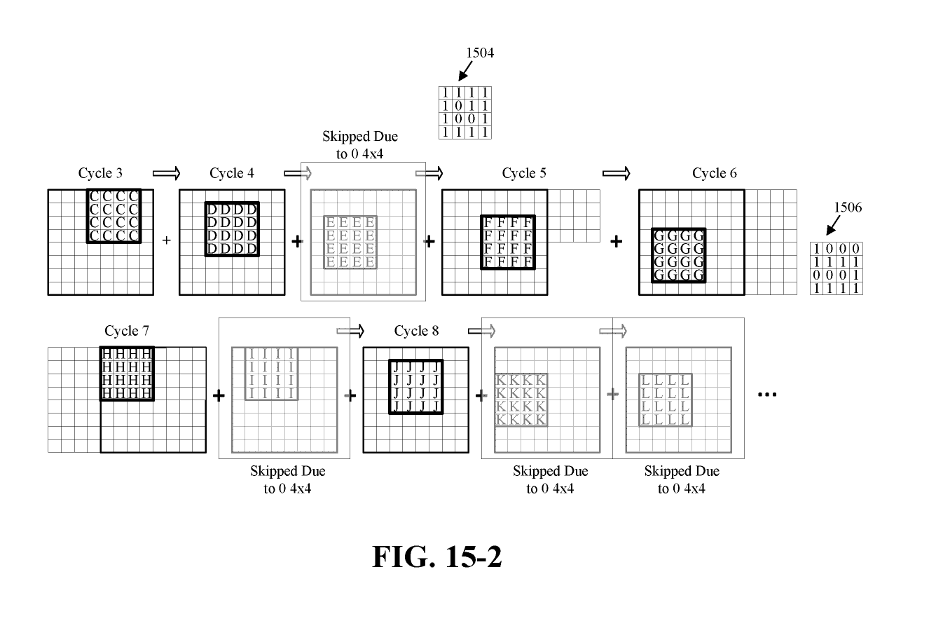

Referring to FIG. 14, the next weight to be processed is weight 1420 in weight matrix 915. In processing weight 1420, the NN engine determines that the 4×4 region 1410 to be processed using weight 1420 is a zero region (e.g., has all zero values). Accordingly, the NN engine may skip processing of region 1410 and weight 1420. No cycles are consumed and no output is generated. The NN engine may continue skipping the weight having a zero value in the lower left hand corner so that the next weight to be processed is the weight having a value of 0.07. The NN engine applies this weight to the corresponding 4×4 region in the fourth cycle. The last weight of weight matrix 915 in the lower right-hand corner has a value of zero and is skipped.

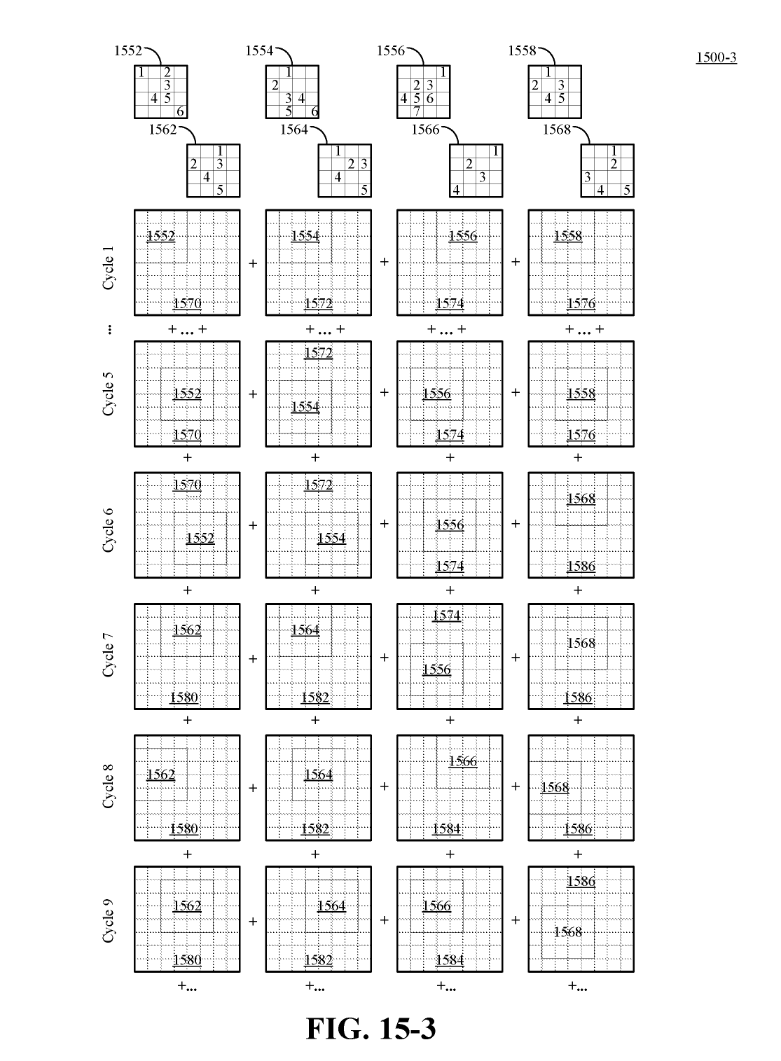

FIGS. 15-1 and 15-2 are diagrams illustrating an example of processing an input feature map by the NN engine of FIG. 5. FIG. 15-3 is a diagram illustrating an example of concurrent processing of input feature maps by multiple instances of the NN engine of FIG. 5. FIGS. 15-1, 15-2, and 15-3 illustrate the sequence of operations that may be performed for retrieving regions of input feature maps and generating the masks used by the NN engine to determine whether to skip processing of a given region. FIGS. 15-1 and 15-2 illustrate processing for one input feature map to generate the contribution of the input feature map to a 4×4 of outputs. FIG. 15-3 illustrates processing for multiple input feature maps.

Referring to FIG. 5, there may be 4, 8, or 16 input data paths running in parallel, with each applying a different weight matrix to a different input feature map (e.g., refer to FIG. 15-3 for further details). The input data paths may be decoupled so that each may apply weights from different positions in their respective weight matrices. For each input map, the weight and 16 inputs may be fed into one of the 4 inputs of the multiply-accumulate circuit each cycle. The 4 inputs may be weighted and added to the accumulator register of the multiply-accumulate circuit. One non-zero weight is applied to 16 neurons per cycle. This example requires 23 (vs. 49) cycles to apply all weights to 16 neurons assuming that no 4×4 regions in the feature map coincide with non-zero weights.

Referring to FIG. 15-1, in cycle −3, in the top row moving from left to right, the NN engine loads a first 4×4 region of an input feature map from memory into data registers for processing. For example, input fetch circuit 524 may fetch the 4×4 region from memory and provide the region to component mask generator 528. Component mask generator 528 loads the region into input data FIFO 526. Further, a component mask 1550 for the first 4×4 region is generated by component mask generator 528 and stored in input data FIFO 526. Each bit of component mask 1550 indicates whether the corresponding 8-bit value in the 4×4 region above is zero or non-zero.

In cycle −2, the NN engine loads a next, or second, 4×4 region of an input feature map from memory into data registers for processing. Further, the NN engine generates a component mask 1552 for the second 4×4 region. In cycle −1, the NN engine loads a next, or third, 4×4 region of the input feature map from memory into data registers for processing. The NN engine also generates a component mask for the third 4×4 region (not labeled). Further, in cycle −1, the NN engine begins generating the alignment mask. The alignment mask indicates whether all elements in a contiguous 4×4 at each alignment are equal to zero.

As pictured, the NN engine generates the first four rows of a horizontal “0” runs mask 1502. For example, alignment mask generator 530 may begin processing the generated component masks to generate the first four rows of horizontal “0” runs mask 1502. Alignment mask generator 530 performs a logical OR operation on the first four bits of the top row indicated in outline and places the result in the top left field of mask 1502. Alignment mask generator 530 performs a logical OR operation on the second, third, fourth, and fifth bits of the top row and places the result in the second field from the left in the top row of mask 1502. Alignment mask generator 530 may continue generating the bit values as pictured where the outlined groups of 4 bits are logically OR'd to generate the circled bits in mask 1502. It should be appreciated that mask 1502 may be generated at one time using an exemplary circuit configuration such as 16 4-input OR gates. Generation of bits is described herein sequentially for purposes of illustration and is not intended to be a limitation of the inventive arrangements disclosed herein.

In cycle 0, the NN engine loads a next, or fourth, 4×4 region of an input feature map from memory into data registers for processing. Further, the NN engine generates a component mask for the fourth 4×4 region. In cycle 0, the NN engine may generate the remainder of mask 1502 by locally OR'ing bits vertically. As pictured, the first four bits of the first column shown in outline are locally OR'd to generate the top left bit of alignment mask 1504. The process may continue to generate the complete 16-bit alignment mask 1504. Bit positions of alignment mask 1504 correspond to the position of the top left corner of the 4×4 region represented by the bit position.

In cycle 1, the NN engine may begin applying weights. For purposes of illustration, the 4×4 region starting in the top left corner is processed using a non-zero weight of “A” as pictured in FIG. 15-1 for cycle 1 and also as illustrated in FIG. 7. Further, as indicated by the top left position of alignment mask 1504, the outlined 4×4 region is non-zero. Accordingly, the NN engine applies the weight A to the outlined 4×4 region in cycle 1.

In cycle 2, the NN engine has skipped the 4×4 region defined by an upper left corner located in the second position from the left in the first row since the weight to be applied is zero as shown in FIG. 7. Instead, the NN engine processes the 4×4 region shown in outline with weight B since weight B is non-zero and alignment mask 1504 indicates non-zero data in the third bit position from the left in the top row.

Referring to FIG. 15-2, in cycle 3, the NN engine processes the next non-zero weight C of FIG. 7 corresponding to the 4×4 region shown in outline for cycle 3. Alignment mask 1504 indicates that the 4×4 region is non-zero according to the fourth bit position from the left in the top row. Accordingly, the NN engine applies the non-zero weight C to the 4×4 region shown in outline.

In cycle 4, the NN engine processes the next non-zero weight D of FIG. 7 corresponding to the 4×4 region shown in outline for cycle 4. Alignment mask 1504 indicates that the 4×4 region is non-zero according to the third bit position from the left in the second row. Accordingly, the NN engine applies the non-zero weight D to the 4×4 region shown in outline.

In cycle 5, the NN engine skips the 4×4 region corresponding to the non-zero weight E of FIG. 7 since the second bit from the left in the third row of alignment mask 1504 indicates that the 4×4 region to be processed by the non-zero weight E is a zero region. Accordingly, in cycle 5, the NN engine processes the next non-zero weight F of FIG. 7 corresponding to the region shown in outline for cycle 5. Alignment mask 1504 indicates that the 4×4 region is non-zero according to the fourth bit position from the left in the third row. Further, in cycle 5 the NN engine retrieves a next 4×4 region for processing.

In cycle 6, the NN engine processes the next non-zero weight G of FIG. 7 corresponding to the 4×4 region shown in outline for cycle 6. Alignment mask 1504 indicates that the 4×4 region is non-zero according to the second bit position from the left in the fourth row. Accordingly, the NN engine applies the non-zero weight G to the 4×4 region shown in outline for cycle 6. In addition, in cycle 6, the NN engine generates the final 16-bit alignment mask 1506.

In cycle 7, the NN engine processes the next non-zero weight H of FIG. 7 corresponding to the 4×4 region shown in outline for cycle 7. Alignment mask 1506 indicates that the 4×4 region is non-zero according to the first bit position from the left in the first row. Accordingly, the NN engine applies the non-zero weight H to the 4×4 region shown in outline for cycle 7.

In cycle 8, the NN engine skips the 4×4 region corresponding to the non-zero weight I of FIG. 7 since the second bit from the left in the first row of alignment mask 1506 indicates that the 4×4 region to be processed using the non-zero weight I is a zero region. Accordingly, in cycle 8, the NN engine processes the next non-zero weight J of FIG. 7 corresponding to the region shown in outline for cycle 8. Alignment mask 1506 indicates that the 4×4 region is non-zero according to the third bit position from the left in the second row.

In starting cycle 9, the NN engine skips the next two 4×4 regions corresponding to weights K and L of FIG. 7 since the first and second bit positions in the third row are zero. The NN engine may continue processing as described.

Referring to FIG. 15-3, the schematic shows concurrent processing 1500-3 by four input data paths (e.g., 502-1, 502-2, 502-3, 502-4 of FIG. 5). The input data paths operate on the weight matrices 1552-1568 and the feature maps 1570-1586. In particular, each column shows the processing for one of the four input data paths over a number of cycles. For example, the operations of the first input data path are shown by the first column; the operations of a second input data path are shown by the second column; the operations of a third input data path are shown by the third column; and the operations of the fourth input data path are shown by the fourth column. In this way, the first row shows the first cycle of the four input data paths, the second row shows the second cycle of the four input data paths, and so on.

As shown in FIG. 15-3, each input data path traverses every fourth input feature map and applies the weights in the corresponding weight matrix, e.g., in as few cycles as possible. When an input data path has processed each non-zero weight, the input data path moves to the next feature map. For example, the first input data path is assigned to convolve the first feature map 1570 with the first weight matrix 1552 and then convolve the fifth feature map 1580 with the fifth weight matrix 1562. The second input data path is assigned to convolve the second feature map 1572 with the second weight matrix 1554 and then convolve the sixth feature map 1582 with the sixth weight matrix 1564. The third input data path is assigned to convolve the third feature map 1574 with the third weight matrix 1556 and then convolve the seventh feature map 1584 with the seventh weight matrix 1566. The fourth input data path is assigned to convolve the fourth feature map 1576 with the fourth weight matrix 1558 and then convolve the eighth feature map 1586 with the eighth weight matrix 1568.

Each of the input data paths can process the input feature maps as described above in connection with the single input data path processing (e.g., as described in connection with FIGS. 15-1, 15-2). During cycles 1 through 5, the input data paths process input feature maps 1570-1576 using the respective weight matrices 1552-1558. Moreover, the first three input data paths are still processing the first four input feature maps 1570-1574, and the fourth input data path completes processing the fourth input feature map 1576. Accordingly, at cycle 6, the first three input data paths continue processing the first four input feature maps 1570-1574, and the fourth input data path starts processing the eighth input feature map 1586 with the weight matrix 1568. At the completion of cycle 6, the first and second input data paths have completed processing the first input feature map 1570 and the second input feature map 1572, respectively.

Accordingly, at cycle 7, the first and second input data paths start processing the fifth input feature map 1580 (with weight matrix 1562) and the sixth input feature map 1582 (with weight matrix 1564), respectively. The third input data path continues processing the third input feature map 1574. The fourth input data path continues processing the eighth input feature map 1586.

At cycles 8 and 9, the first and second input data paths continue processing the fifth input feature map 1580 and the sixth input feature map 1582. The third input data path has completed processing the third input feature map 1574 and starts processing the seventh input feature map 1584 using the weight matrix 1566. The fourth input data path continues processing the eighth input feature map 1586.

Accordingly, in example embodiments, input data paths can process input feature maps concurrently and independently. In response to completing processing of an input feature map, the input data path can move to the next input feature map regardless of whether the other input data paths have completed processing their respective input feature maps. However, over enough input maps, the processing times of the input data paths may tend to balance. FIG. 15-3 illustrates that each data path may operate on a different input feature map using a different convolution kernel, each applied over a variable number of cycles according to sparsity of the kernel and input data.

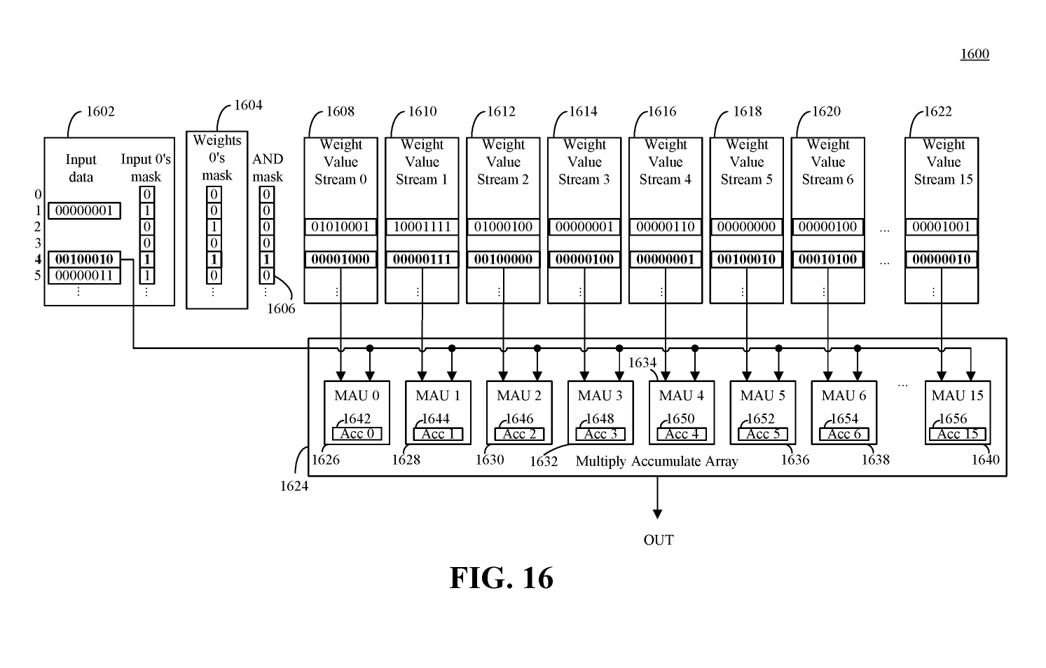

FIG. 16 is a diagram illustrating an exemplary engine 1600 for processing one or more classification layers of a neural network or for processing in a general vector product mode. In the illustrated embodiment, the engine 1600 includes memory 1602 storing input data and an input-0 mask (e.g., an alignment mask) and memory 1604 storing weights-0 mask (e.g., a bitmask such as the weight mask). As described above, the input can correspond to input feature maps, the input-0 mask is data indicative of locations of zero and non-zero values of the input data, and the weights-0 mask is data indicative of locations of zero and non-zero values of the weight matrices. The weight matrices data are streamed in parallel weight value streams 1608-1622.

An AND mask 1606 (e.g., a bitmask) is used to store the results of an AND logical operation on the input-0 mask and the weight-0 mask, indicating the locations where both the input data and the weight matrices data are non-zero. In response to a determination that an entry of the input data and the corresponding entry of a weight matrix are non-zero, the entries are provided to multiply-accumulate array 1624 for processing. In particular, the multiply-accumulate array 1624 includes a number of multiply-accumulate units, such as MAUs 1626-1640, for parallel processing. The MAUs 1626-1640 include respective accumulate registers 1642-1656. Further details of the engine 1600 are described below.

During operation of an example embodiment, compressed weight data is read from memory such as an SRAM and a weight decompressor (e.g., the weight processing circuit 508 of FIG. 5) decompresses one weight position stream, which results in the AND mask 1606 indicating the positions of non-zero weights and 16 weight value streams 1608-1622 in parallel. Each weight value stream has non-zero weights that are to be applied to the input data values to generate one output result. Zero valued entries are shown as gaps between values since these are not stored.

In parallel, the input-0 mask and packed non-0 input data values are read from SRAM (e.g., the memory 1602). The input-0 mask can be generated on the fly as input values are read from SRAM, or computed and stored in SRAM at the end of processing the prior layer. Each bit in the input-0 mask indicates whether the input value at that position is zero or non-zero.

As stated above, the AND mask 1606 serves as a combined mask and is computed by applying a logical AND operation on the input-0 mask and the weights-0 mask. The resulting AND mask 1606 indicates at which positions weights are to be applied to input data values. For instance, positions with non-0 inputs and non-0 weights are marked with a ‘1’ in the AND mask 1606, and other positions are marked with a ‘0.’

According to the position of the next ‘1’ in the AND mask 1606, prior non-zero input values and prior non-zero weights are discarded (e.g., omitted from processing). In the illustrated example, the first location where there is a non-0 input and corresponding non-0 weight is the 4 entry (shown in BOLD). Each set of non-0 input data and its corresponding non-0 weights are found in one processing step, rather than iteratively searching. As a result, a new set of non-0 values are presented to the MAU 1626-1640 inputs each cycle and idle cycles are reduced.

The selected input data corresponding the ‘1’ entry in the AND mask 1606 is broadcast to the first input of each of the MAUs 1626-1640. Each of the corresponding 16 non-zero weight values are sent to the respective second input of the MAUs 1626-1640.

In an example embodiment, the above described process can be repeated with 4, 8, more identical units operating in parallel on a subset of the input nodes. As such, there are 4 (or 8) input fetch paths traversing different subsets of the input data values and their corresponding weights in a similar way—but decoupled, each cycle feeding non-0 input values and corresponding non-0 weights to the other multi-input MAU unit inputs. Only 2 of the MAU inputs are shown. There are 8 (or 16) overall.

In an example embodiment, as mentioned, the 4 or 8 identical units can be decoupled and operate at differing rates through their assigned inputs and weights. This enables efficient skipping of all 0s in each subset. The zero input data values and zero weights can be at different positions and local densities in each subset of inputs.

In an example embodiment, the input data might be reformatted into masks and packed non-0 value format as it is generated in the prior layer processing. In SRAM, input can be stored as a 128-bit 0-mask, followed by 16 128-bit words of values, with all non-0 values packed together in the initial words. The remainder of the 16 words can be 0s or uninitialized.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution NN engine, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the term “executable operation” or “operation” is a task performed by a data processing system or a processor within a data processing system unless the context indicates otherwise. Examples of executable operations include, but are not limited to, “processing,” “computing,” “calculating,” “determining,” “displaying,” “comparing,” or the like. In this regard, operations refer to actions and/or processes of the data processing system, e.g., a computer system, or similar electronic computing device, that manipulates and transforms data represented as physical (electronic) quantities within the computer system's registers and/or memories into other data similarly represented as physical quantities within the computer system memories and/or registers or other such information storage, transmission or display devices.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “program code,” “software,” “application,” and “executable code” mean any expression, in any language, code or notation, of a set of instructions intended to cause a data processing system to perform a particular function either directly or after either or both of the following: a) conversion to another language, code, or notation; b) reproduction in a different material form. Examples of program code may include, but are not limited to, a subroutine, a function, a procedure, an object method, an object implementation, an executable application, an applet, a servlet, source code, object code, a shared library/dynamic load library and/or other sequence of instructions designed for execution on a computer system.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

From time-to-time, the term “signal” may be used within this disclosure interchangeably to describe physical structures such as terminals, pins, signal lines, wires, and the corresponding signals propagated through the physical structures. The term “signal” may represent one or more signals such as the conveyance of a single bit through a single wire or the conveyance of multiple parallel bits through multiple parallel wires. Further, each signal may represent bi-directional communication between two, or more, components connected by the signal.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and/or procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The corresponding structures, materials, acts, and equivalents of all means or step plus function elements that may be found in the claims below are intended to include any structure, material, or act for performing the function in combination with other claimed elements as specifically claimed.

A method of implementing a neural network may include determining whether to process a combination of a first region of an input feature map and a first region of a convolution kernel and, responsive to determining to process the combination, performing a convolution operation on the first region of the input feature map using the first region of the convolution kernel to generate at least a portion of an output feature map.

Determining whether to process the combination of the first region of the input feature map and the first region of the convolution kernel may include identifying a non-zero value in the first region of the input feature map and a non-zero value in the first region of the convolution kernel.

Determining whether to process the combination of the first region of the input feature map and the first region of the convolution kernel may include generating a mask indicating zero and non-zero portions of at least one of the first region of the input feature map or the first region of the convolution kernel. The mask may be generated responsive to reading the first region of the input feature map or the first region of the convolution kernel from a memory.

In another aspect, a first mask is generated indicating zero and non-zero portions of the first region of the input feature map and a second mask is generated indicating zero and non-zero portions of the first region of the convolution kernel. In that case, the method may include comparing the first mask and the second mask.

The method may include skipping a convolution operation on a further combination of a second region of the input feature map and a second region of the convolution kernel responsive to determining that the second region of the input feature map includes all zero values or responsive to determining that the second region of the convolution kernel includes all zero values.

In a further aspect, the determining whether to process the combination of the first region of the input feature map and the performing the convolution operation on the first region of the input feature map are implemented by each of a plurality of data paths operating independently and concurrently, and wherein each data path operates on a different input feature map using a different convolution kernel each applied over a variable number of cycles according to sparsity of convolution kernel data and input data.

An apparatus for implementing a neural network may include a fetch circuit configured to retrieve regions of input feature maps from a memory under control of a control circuit, a mask generation and weight application control circuit configured to determine whether to process a combination of a first region of an input feature map and a first region of a convolution kernel, and a convolution circuit configured to perform a convolution operation on the combination responsive to the determination by the mask generation and weight application control circuit to process the combination.

The apparatus may include an accumulation circuit configured to sum outputs from the convolution circuit, an activation circuit configured to apply an activation function to the summed outputs of the accumulation circuit, and a pooling and sub-sampling circuit coupled to the activation circuit.

The mask generation and weight application control circuit may be configured to determine that the combination is to be processed responsive to determining that the first region of the input feature map includes a value other than zero and that the first region of the convolution kernel includes a value other than zero.

The mask generation and weight application control circuit may be configured to generate a mask indicating zero and non-zero portions of at least one of the first region of the input feature map or the first region of the convolution kernel. In one aspect, the mask is generated responsive to reading the first region of the input feature map or the first region of the convolution kernel from a memory.

In another aspect, a first mask is generated indicating zero and non-zero portions of the first region of the input feature map and a second mask is generated indicating zero and non-zero portions of the first region of the convolution kernel. In that case, the mask generation and weight application control circuit may be configured to compare the first mask and the second mask.

The mask generation and weight application control circuit may be further configured to determine to skip convolution processing of a further combination of a second region of the input feature map and a second region of the convolution kernel responsive to determining that the second region of the input feature map includes all zero values or that the second region of the convolution kernel includes all zero values.

An apparatus for implementing a neural network may include a weight processing circuit configured to determine whether weights to be applied to regions of input feature maps are zero, a data staging circuit configured to determine whether the regions of the input feature maps are zero, and a multiply-accumulate circuit configured to apply only non-zero weights to the regions of the input feature maps that are non-zero.

The apparatus may include an activation circuit coupled to the multiply-accumulate circuit and a pooling and sub-sampling circuit coupled to the activation circuit.

In one aspect, responsive to determining that a selected weight is zero, the weight processing circuit is configured not to output the selected weight to the multiply-accumulate circuit and to instruct the data staging circuit not to output the region of the input feature map corresponding to the selected weight to the multiply-accumulate circuit.

In another aspect, responsive to determining that a selected region includes only zero values, the data staging circuit is configured not to output the selected region to the multiply-accumulate circuit and instructs the weight processing circuit not to output the weight corresponding to the selected region to the multiply-accumulate circuit.

The weight processing circuit may include a weight decompressor configured to decompress a plurality of weights retrieved from a memory and generate a mask indicating weights of the plurality of weights that are zero.

The data staging circuit may include a component mask generator configured to generate a component mask indicating which regions of an input feature map consist of only zeros and an alignment mask generator configured to generate an alignment mask indicating whether all values in a contiguous region at each alignment are equal to zero.

The data staging circuit may also include a weight application controller configured to instruct the weight processing circuit not to output a non-zero weight to the multiply-accumulate circuit responsive receiving an alignment mask from the alignment mask generator for a region corresponding to the non-zero weight indicating that all values in the region at each alignment are equal to zero.

In another aspect, the multiply-accumulate circuit includes a multiply-accumulate array having a plurality of multiply-accumulate units configured to operate in parallel. Each multiply-accumulate unit may be configured to apply only non-zero weight values of a weight value stream to the non-zero input data to implement convolution or vector product operations.

The description of the inventive arrangements provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A method of implementing a neural network, the method comprising:
determining whether to process a combination of a first region of an input feature map and a first region of a convolution kernel; and
responsive to determining to process the combination, performing a convolution operation on the first region of the input feature map using the first region of the convolution kernel to generate at least a portion of an output feature map.

2. The method of claim 1, wherein the determining whether to process the combination of the first region of the input feature map and the first region of the convolution kernel comprises:
identifying a non-zero value in the first region of the input feature map and a non-zero value in the first region of the convolution kernel.

3. The method of claim 1, wherein the determining whether to process the combination of the first region of the input feature map and the first region of the convolution kernel comprises:
generating a mask indicating zero and non-zero portions of at least one of the first region of the input feature map or the first region of the convolution kernel.

4. The method of claim 3, wherein the mask is generated responsive to reading the first region of the input feature map or the first region of the convolution kernel from a memory.

5. The method of claim 3, wherein a first mask is generated indicating zero and non-zero portions of the first region of the input feature map and a second mask is generated indicating zero and non-zero portions of the first region of the convolution kernel, the method further comprising:
comparing the first mask and the second mask.

6. The method of claim 1, further comprising:
skipping a convolution operation on a further combination of a second region of the input feature map and a second region of the convolution kernel responsive to determining that the second region of the input feature map includes all zero values or responsive to determining that the second region of the convolution kernel includes all zero values.

7. The method of claim 1, wherein the determining whether to process the combination of the first region of the input feature map and the performing the convolution operation on the first region of the input feature map are implemented by each of a plurality of data paths operating independently and concurrently, and wherein each data path operates on a different input feature map using a different convolution kernel each applied over a variable number of cycles according to sparsity of convolution kernel data and input data.

8. An apparatus for implementing a neural network, the apparatus comprising:
a fetch circuit configured to retrieve regions of input feature maps from a memory under control of a control circuit;
a mask generation and weight application control circuit configured to determine whether to process a combination of a first region of an input feature map and a first region of a convolution kernel; and
a convolution circuit configured to perform a convolution operation on the combination responsive to the determination by the mask generation and weight application control circuit to process the combination.

9. The apparatus of claim 8, further comprising:
an accumulation circuit configured to sum outputs from the convolution circuit;
an activation circuit configured to apply an activation function to the summed outputs of the accumulation circuit; and
a pooling and sub-sampling circuit coupled to the activation circuit.

10. The apparatus of claim 8, wherein the mask generation and weight application control circuit is configured to determine that the combination is to be processed responsive to determining that the first region of the input feature map includes a value other than zero and that the first region of the convolution kernel includes a value other than zero.

11. The apparatus of claim 10, wherein the mask generation and weight application control circuit is further configured to generate a mask indicating zero and non-zero portions of at least one of the first region of the input feature map or the first region of the convolution kernel.

12. The apparatus of claim 11, wherein the mask is generated responsive to reading the first region of the input feature map or the first region of the convolution kernel from a memory.

13. The apparatus of claim 11, wherein a first mask is generated indicating zero and non-zero portions of the first region of the input feature map and a second mask is generated indicating zero and non-zero portions of the first region of the convolution kernel, wherein the mask generation and weight application control circuit is further configured to compare the first mask and the second mask.

14. The apparatus of claim 8, wherein the mask generation and weight application control circuit is further configured to determine to skip convolution processing of a further combination of a second region of the input feature map and a second region of the convolution kernel responsive to determining that the second region of the input feature map includes all zero values or that the second region of the convolution kernel includes all zero values.

15. An apparatus for implementing a neural network, the apparatus comprising:
a weight processing circuit configured to determine whether weights to be applied to regions of input data are zero;
a data staging circuit configured to determine whether the regions of the input data are zero; and
a multiply-accumulate circuit configured to apply only non-zero weights to the regions of the input data that are non-zero.

16. The apparatus of claim 15, wherein:
responsive to determining that a selected weight is zero, the weight processing circuit is configured not to output the selected weight to the multiply-accumulate circuit and to instruct the data staging circuit not to output the region of the input data corresponding to the selected weight to the multiply-accumulate circuit.

17. The apparatus of claim 15, wherein:
responsive to determining that a selected region comprises only zero values, the data staging circuit is configured not to output the selected region to the multiply-accumulate circuit and instructs the weight processing circuit not to output the weight corresponding to the selected region to the multiply-accumulate circuit.

18. The apparatus of claim 15, wherein the weight processing circuit comprises a weight decompressor configured to decompress a plurality of weights retrieved from a memory and generate a mask indicating weights of the plurality of weights that are zero.

19. The apparatus of claim 15, wherein the data staging circuit comprises:
a component mask generator configured to generate a component mask indicating which regions of the input data consist of only zeros;
an alignment mask generator configured to generate an alignment mask indicating whether all values in a contiguous region at each alignment are equal to zero; and
weight application controller configured to instruct the weight processing circuit not to output a non-zero weight to the multiply-accumulate circuit responsive receiving an alignment mask from the alignment mask generator for a region corresponding to the non-zero weight indicating that all values in the region at each alignment are equal to zero.

20. The apparatus of claim 15, wherein the multiply-accumulate circuit comprises:
a multiply-accumulate array having a plurality of multiply-accumulate units configured to operate in parallel, wherein each multiply-accumulate unit is configured to apply only non-zero weight values of a weight value stream to the non-zero input data to implement convolution or vector product operations.
